(19) United States
(12) Patent Application Publication
(10) Pub. No.: US 2025/0264625 A1
(43) Pub. Date: Aug. 21, 2025

(54) INVERTING VERTICAL SEISMIC PROFILING DATA FOR EARTH PROPERTIES WITH MACHINE LEARNING AND AUGMENTED SYNTHETIC SEISMIC DATA

(71) Applicant: SAUDI ARABIAN OIL COMPANY, Dhahran (SA)

(72) Inventor: Hussain Abbas S. Almarzooq, Dhahran (SA)

(73) Assignee: SAUDI ARABIAN OIL COMPANY, Dhahran (SA)

(21) Appl. No.: 18/581,965

(22) Filed: Feb. 20, 2024

(51) Int. Cl. G01V 1/40; E21B 44/00; G01V 1/30

(52) U.S. Cl. CPC G01V 1/40; E21B 44/00; G01V 1/307; E21B 2200/22; G01V 2210/23; G01V 2210/677

(57) ABSTRACT

A method for determining earth property data from field vertical seismic profiling (VSP) data. The method includes obtaining a survey dataset regarding a geological region of interest encompassing a set of drilled wells. The survey dataset includes VSP data and well data corresponding to the drilled wells. The method also includes: extracting, from the VSP data, a first wavelet; constructing a set of pseudo-wells; determining a reflectivity series for each pseudo-well based on the well data; and generating a first synthetic seismic dataset for each pseudo-well based on its reflectivity series and the first wavelet. The method further includes training a set of machine learning models to predict earth property data given a VSP dataset using the first synthetic seismic dataset and target data. The method further includes determining, with the set of machine learning models, predicted earth property data from a field VSP dataset and planning a wellbore path.

### BACKGROUND

Vertical seismic profiling (VSP) may be performed near a well. VSP inversion is a process of estimating subsurface formation properties (i.e., subsurface model(s)), often referred to as earth properties, from VSP data. In some instances, VSP inversion is applied to estimate subsurface formation properties ahead of a drill bit or in an undrilled subsurface formation (e.g., “lookahead VSP inversion”). Earth properties can include the reflectivity, acoustical impedance, velocity, density, and depth to target of subsurface formations. Techniques for determining earth properties ahead of the drill bit include using a sparse spike deconvolution approach on the VSP data with an extracted or generated wavelet, and Gardener estimation to predict the velocity (and depth to target) in the undrilled formation. However, there remains a need to reduce the uncertainty in the conventional lookahead VSP inversion approach and to deliver faster earth property predictions from VSP data.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method. The method includes obtaining a survey dataset regarding a geological region of interest, the geological region of interest includes a set of drilled wells. The survey dataset includes vertical seismic profiling data associated with the set of drilled wells and well data for each drilled well in the set of drilled wells. The method also includes: extracting, from the vertical seismic profiling data, a first wavelet; constructing a set of pseudo-wells encompassed by the geological region of interest; determining, for each pseudo-well in the set of pseudo-wells, a reflectivity series based on the well data of the set of drilled wells; and generating a first synthetic seismic dataset for each pseudo-well in the set of pseudo-wells based on the reflectivity series for that pseudo-well and the first wavelet. The method further includes obtaining target data corresponding to an earth property for each pseudo-well and training a set of machine learning models including at least a first machine-learned model to predict earth property data given a vertical seismic profiling dataset using the first synthetic seismic dataset and target data of one or more of pseudo-wells in the set of pseudo-wells. The method further includes determining, with the set of machine learning models, predicted earth property data from a field vertical seismic profiling dataset and planning a wellbore path using the predicted earth property data.

In one aspect, embodiments disclosed herein relate to a system. The system includes a set of machine learning models including at least a first machine-learned model and a computer. The computer configured to: obtain a survey dataset regarding a geological region of interest, the geological region of interest including a set of drilled wells. The survey dataset includes vertical seismic profiling data associated with the set of drilled wells and well data for each drilled well in the set of drilled wells. The computer is also configured to: extract, from the vertical seismic profiling data, a first wavelet; construct a set of pseudo-wells encompassed by the geological region of interest; determine, for each pseudo-well in the set of pseudo-wells, a reflectivity series based on the well data of the set of drilled wells; and generate a first synthetic seismic dataset for each pseudo-well in the set of pseudo-wells based on the reflectivity series for that pseudo-well and the first wavelet. The computer is further configured to obtain target data corresponding to an earth property for each pseudo-well and train the set of machine learning models comprising the first machine-learned model to predict earth property data given a vertical seismic profiling dataset using the first synthetic seismic dataset and target data of one or more pseudo-wells in the set of pseudo-wells. The computer is further configured to determine, with the set of machine learning models, predicted earth property data from a field vertical seismic profiling dataset and plan a wellbore path using the predicted earth property data.

In one aspect, embodiments disclosed herein relate to a non-transitory machine-readable medium including a plurality of machine-readable instructions executed by one or more processors. The plurality of machine-readable instructions cause the one or more processors to perform a set of steps. The steps include obtaining a survey dataset regarding a geological region of interest, the geological region of interest including a set of drilled wells. The survey dataset includes vertical seismic profiling data associated with the set of drilled wells and well data for each drilled well in the set of drilled wells. The steps further include: extracting, from the vertical seismic profiling data, a first wavelet; constructing a set of pseudo-wells encompassed by the geological region of interest; determining, for each pseudo-well in the set of pseudo-wells, a reflectivity series based on the well data of the set of drilled wells; and generating a first synthetic seismic dataset for each pseudo-well in the set of pseudo-wells based on the reflectivity series for that pseudo-well and the first wavelet. The steps further include obtaining target data corresponding to an earth property for each pseudo-well and training a set of machine learning models including at least a first machine-learned model to predict earth property data given a vertical seismic profiling dataset using the first synthetic seismic dataset and target data of one or more of pseudo-wells in the set of pseudo-wells. The steps further include determining, with the set of machine learning models, predicted earth property data from a field vertical seismic profiling dataset and planning a wellbore path using the predicted earth property data.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a seismic survey in accordance with one or more embodiments.

FIG. 2 depicts a vertical seismic profiling survey in accordance with one or more embodiments.

FIGS. 3A-3E illustrate the processing of vertical seismic profiling data to form a corridor stack in accordance with one or more embodiments.

FIG. 4 depicts a workflow in accordance with one or more embodiments.

FIG. 5 depicts a workflow in accordance with one or more embodiments.

FIG. 6 depicts a neural network in accordance with one or more embodiments.

FIG. 7 depicts a synthetic data generation process in accordance with one or more embodiments.

FIG. 8A depicts wellbores, horizons, and tops in a region of interest in accordance with one or more embodiments.

FIG. 8B depicts an interpolated three-dimensional volume in accordance with one or more embodiments.

FIG. 8C depicts pseudo-well selection in a regio of interest in accordance with one or more embodiments.

FIG. 8D depicts pseudo-well data in accordance with one or more embodiments.

FIG. 8E depicts the convolution of pseudo-well reflectivity series with a wavelet in accordance with one or more embodiments.

FIG. 8F depicts synthetic VSP data in accordance with one or more embodiments.

FIG. 9 depicts a flowchart in accordance with one or more embodiments.

FIG. 10 depicts a flowchart in accordance with one or more embodiments.

FIG. 11 depicts a drilling system in accordance with one or more embodiments.

FIG. 12 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to an “earth property” can include reference to one or more of such earth properties.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

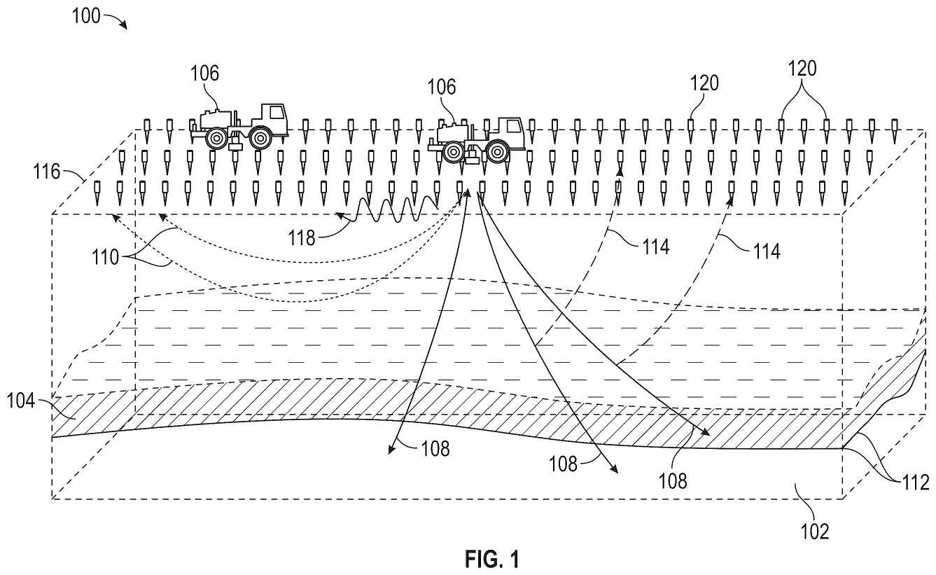

In the following description of FIGS. 1-12, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Vertical seismic profiling (VSP) data may be inverted to determine earth properties in subsurface formations including undrilled subsurface formations (e.g., ahead of the drill bit). In general, embodiments disclosed herein relate to methods and systems to improve VSP inversion results.

FIG. 1 shows a surface seismic (SS) survey (100) of a subterranean region of interest (102), which may contain a hydrocarbon reservoir (104). In some cases, the subterranean region of interest (102) may lie beneath a lake, sea, or ocean. In other cases, the subterranean region of interest (102) may lie beneath an area of dry land. The seismic survey (100) may utilize a seismic source (106) that generates radiated seismic waves (108) (i.e., emitted energy, wavefield). The type of seismic source (106) may depend on the environment in which it is used, for example on land the seismic source (106) may be a Vibroseis truck or an explosive charge, but in water the seismic source (106) may be an airgun. The radiated seismic waves (108) may return to the surface of the Earth (116) as refracted seismic waves (110) or may be reflected by geological discontinuities (112) (interfaces between subsurface regions with differing lithostratigraphic properties) and return to the surface as reflected seismic waves (114). The radiated seismic waves may propagate along the surface as Rayleigh waves or Love waves, collectively known as ground-roll (118). Vibrations associated with ground-roll (118) do not penetrate far beneath the surface of the Earth (116) and hence are not influenced, nor contain information about, portions of the subterranean region of interest (102) where hydrocarbon reservoirs (104) are typically located. Seismic receivers (120) located on or near the surface of the earth (116) detect reflected seismic waves (114), refracted seismic waves (110) and ground-roll (118).

The refracted seismic waves (110), reflected seismic waves (114), and ground-roll (118) generated by a single activation of the seismic source (106) are recorded by a seismic receiver (120) as a time-series representing the amplitude of ground-motion at a sequence of discrete sample times. Usually the origin of the time-series, denoted t=0, is determined by the activation time of the seismic source (106). This time-series may be denoted a seismic “trace”. The seismic receivers (120) are positioned at a plurality of seismic receiver locations which we may denote with (xᵣ, yᵣ), where x and y represent orthogonal axes on the surface of the Earth (116) above the subterranean region of interest (102). Thus, the plurality of seismic traces generated by activations of the seismic source (106) at a single location may be represented as a three-dimensional “3D” volume with axes (xᵣ, yᵣ, t) where (xᵣ, yᵣ) represents the location of the seismic receiver (120) and t denotes the time sample at which the amplitude of ground-motion was measured. The collection of seismic traces is herein referred to as a seismic dataset.

However, a seismic survey (100) may include recordings of seismic waves generated by a seismic source (106) sequentially activated at a plurality of seismic source locations denoted (xₛ, yₛ). In some cases, a single seismic source (106) may be activated sequentially at each source location. In other cases, a plurality of seismic sources (106) each positioned at a different location may be activated sequentially. In some cases, a plurality of seismic sources (106) may be activated during the same time period, or during overlapping time periods.

Once acquired, a seismic dataset may undergo a myriad of pre-processing steps. These pre-processing steps may include, but are not limited to, reducing signal noise; applying move-out corrections; organizing or resampling the traces according to a regular spatial pattern (i.e., regularization); and data visualization. One with ordinary skill in the art will recognize that many pre-processing (or processing) steps exist for dealing with a seismic dataset. As such, one with ordinary skill in the art will appreciate that not all pre-processing (or processing) steps can be enumerated herein and that zero or more pre-processing (or processing) steps may be applied with the methods disclosed herein without imposing a limitation on the instant disclosure.

The seismic dataset obtained from a surface seismic (SS) survey may be processed to identify parameters associated with the region of interest (102). These parameters include the location of horizons in the region of interest, where a horizon is a plane indicating a geological formation boundary. The SS data may also be processed to identify the tops, where a top is a geological formation top (upper boundary), where a top is defined as the intersection between a horizon and a wellbore.

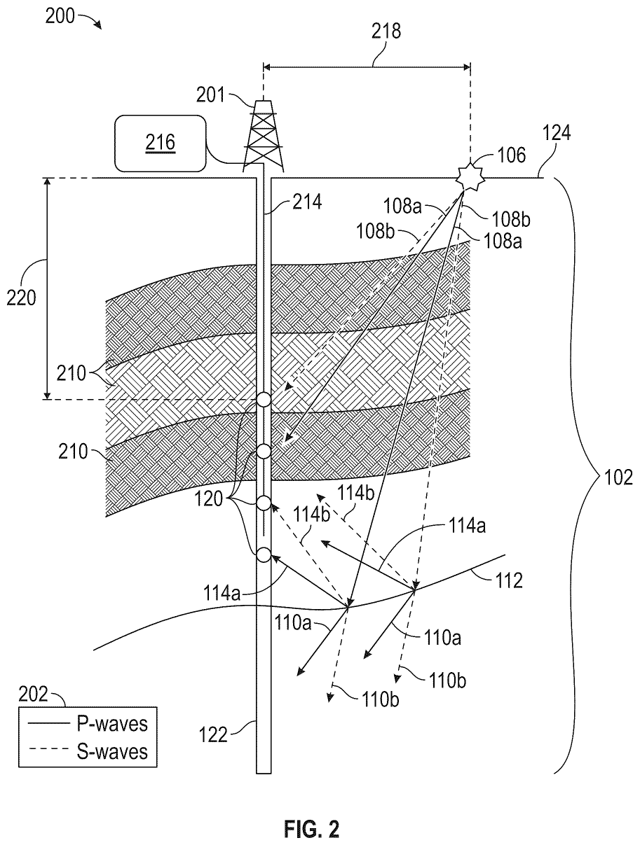

A vertical seismic profiling (VSP) survey may be performed during or following the drilling of a well. FIG. 2 depicts a VSP survey (200) in accordance with one or more embodiments. A VSP survey (200) may use a VSP acquisition system to generate and record VSP data. The VSP acquisition system may include one or more seismic sources (106) and multiple seismic receivers (120). Generally, the seismic receivers (120) are suspended in a wellbore (122) that traverses various subsurface formations (210). Each VSP acquisition system may be designed for one or more seismic source-seismic receiver configurations. Configurations may include zero-offset VSP, offset VSP, walkaway VSP, walk-above VSP, and seismic-while-drilling VSP. Zero-offset VSP may use one or more stationary or static seismic sources (106) located near a drill rig (201) on a surface of the earth (124) and multiple dynamic seismic receivers (120) located within a well (122) (i.e., wellbore). Offset VSP may use one or more static seismic sources (106) located some distance (218) away from the drill rig (201) on the surface of the earth (124) and multiple dynamic seismic receivers (120) downhole. Walkaway VSP may use one or more dynamic seismic sources (106) located on the surface of the earth (124) and multiple static seismic receivers (120) downhole. Walk-above VSP may use multiple static seismic sources (106) located on the surface of the earth (124) and multiple static seismic receivers (120) downhole. In this configuration, the seismic sources (106) are often directly above the seismic receivers (120) in a deviated well (not shown). Seismic-while-drilling VSP may use the dynamic drill bit as the seismic source (106) downhole with multiple static seismic receivers (120) on the surface of the earth (124). Thus, FIG. 2 may depict numerous types of VSP surveys (200) such as offset VSP or walkaway VSP. Hereinafter, “VSP data” may be data collected using any VSP configuration.

In FIG. 2, the seismic receivers (120) are suspended from the drill rig (201) using a means of conveyance (214). The means of conveyance (214) may be a wireline cable, fiber optic cable, coil tubing, drill pipe, wired drill pipe, or any other conveyance (214) known to a person of ordinary skill in the art. The means of conveyance (214) provides mechanical support for the seismic receivers (120) in the well (122). Further, the means of conveyance (214) may provide electrical power to the seismic receivers (120), transmit data recorded by the seismic receivers (120) to a recording facility (216) on the surface of the earth (124), or both. In land operations, the recording facility (216) may be mounted within a truck. In sea operations, the recording facility (216) may be part of the drill rig (201), production platform, or ship.

Continuing with FIG. 2, the seismic source (106) generates radiated seismic waves (108, 108a, 108b) each of which may propagate along a variety of paths. First, a radiated seismic wave (108a, 108b) may propagate directly through the subterranean region of interest (102). Second, a radiated seismic wave (108a, 108b) may propagate through the subterranean region of interest (102) and reflect at one or more geological discontinuities (112) as reflected seismic waves (114a, 114b). Third, a radiated seismic wave (108a, 108b) may propagate through the subterranean region of interest (102) and refract at one or more geological discontinuities (112) as refracted seismic waves (110a, 110b). Some radiated seismic waves (108a, 108b), reflected seismic waves (114a, 114b), and refracted seismic waves (110a, 110b) may be P-waves (108a, 114a, and 110a) and others may be S-waves (108b, 114b, and 110b) as shown by the key (202). Further, refracted or reflected S-waves may produce both S-waves and P-waves. Further still, refracted or reflected P-waves may produce both P-waves and S-waves.

Continuing still with FIG. 2, each seismic receiver (120) may detect and record the vibrations caused by radiated seismic waves (108a, 108b), reflected seismic waves (114a, 114b), and refracted seismic waves (110a, 110b) as seismic traces. The collection of seismic traces is denoted “VSP data.” Each pre-defined time sample within each seismic trace records the amplitude of the vibration caused by the radiated seismic waves (108a, 108b), reflected seismic waves (114a, 114b), and refracted seismic waves (110a, 110b). The amplitudes may be positive or negative at various times along each seismic trace.

As previously described, SS data and VSP data may present multiple seismic wave types, such as P-waves and S-waves, and multiple seismic wave directions, such as towards the center of the earth and towards the surface of the earth (124). Wavefield separation methods may be used to separate SS data and VSP data by seismic wave type and/or seismic wave direction. For example, wavefield separation methods may be used to separate SS data such that the SS data only presents P-waves directed towards the center of the earth. Further, wavefield separation methods may be used to separate VSP data such that the VSP data only presents P-waves. Wavefield separation methods include, but are not limited to, first break picking, median filtering, mean filtering, eigenvector filtering, masking filtering, Radon transform methods, or any combination of these methods. Further, wavefield separation methods may be performed in, but not limited to, the time-depth domain, frequency-wavenumber domain, and time-slowness domain.

For example, first breaking picking may separate VSP data by seismic wave type by exploiting the concept that, in general, P-waves travel faster than S-waves. Thus, at any seismic receiver depth (220), P-waves arrive before S-waves. First break picking may be performed manually, automatically, or semi-automatically. A person of ordinary skill will appreciate the numerous first break picking methods available such as interpolation algorithms, machine learning methods, the modified energy ratio (MER) method, and Coppens' method.

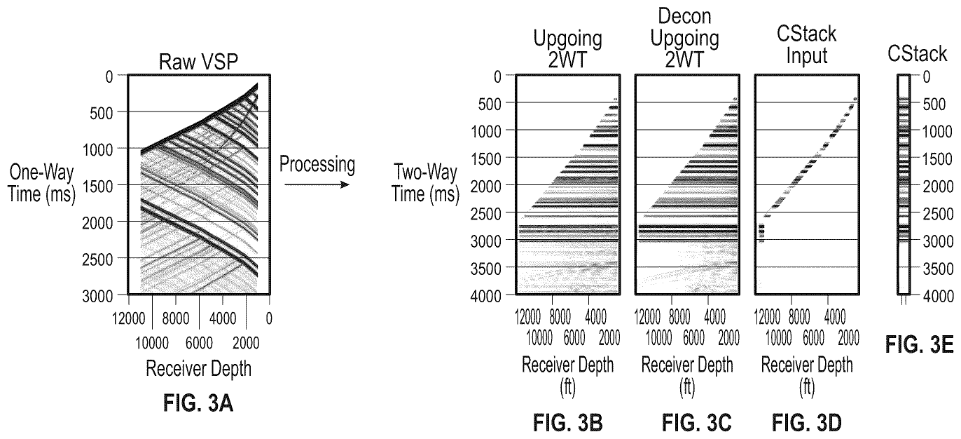

FIG. 3A displays VSP data (300) following first break picking. Each seismic trace (302) is displayed relative to arrival time (304) (hereinafter also “time”) at a seismic receiver (120), seismic receiver depth (220), and amplitude of vibration. Time (304) presents on the ordinate and seismic receiver depth (220) presents on the abscissa. VSP data may also be processed to form a corridor stack. A corridor stack is a summation of some of the traces in an upgoing vertical seismic profile (VSP) that has been processed to retain only primary reflection events and that has been time shifted to their two-way arrival times at the surface. FIG. 3B to FIG. 3D illustrate example steps to process the VSP data of FIG. 3A to obtain the corridor stack shown in FIG. 3E. The VSP data of FIG. 3A is first processed to separate the upgoing waves (primary reflection events), time shifted to their two-way arrival times at the surface. The upgoing waves of FIG. 3B may then be processed by deconvolution methods to demultiple and deghost the data (FIG. 3C). A section of the data from FIG. 3C is then selected, as shown in FIG. 3D, and formed into the corridor stack of FIG. 3E.

In one aspect, embodiments disclosed herein relate to a method to improve VSP inversion, which is the process of estimating from VSP data a model of subsurface formation properties, such as its reflectivity or acoustical impedance. Typically, a convolutional model is assumed in which the VSP data is considered to be a seismic wavelet convolved with a reflectivity series. Gardner's relation is then used to determine the earth properties, such as velocity or density. However, the invention described herein is unique and represents substantial improvement over prior works by providing a robust generalized machine-learned model to provide VSP inversion. Embodiments disclosed herein describe methods and systems for generating synthetic well data and associated synthetic VSP data from real well log data and real seismic data, respectively. Additionally, embodiments described herein utilize a machine-learned model that has been trained on synthetic pseudo-well data to determine one or more earth properties given VSP data. Consequently, a major improvement provided by the instant disclosure is that the trained machine-learned model produced herein is robust and capable of generalizing to new, unseen, and real seismic datasets.

Conventional VSP inversion suffers from several limitations that can cause significant uncertainties in the data. These uncertainties derive from the fact that temporal variations in the wavelet are not considered, the methods rely on guesses or nearby well for the low frequency model of acoustic impedance, and they also rely on either empirical relationships (Gardner's) or nearby wells for the transformation from acoustic impedance to velocity. The instant disclosure overcomes these limitations by implicitly training for them in the deep learning model (variation in wavelets, models, and geology during training) so as to generalize the model.

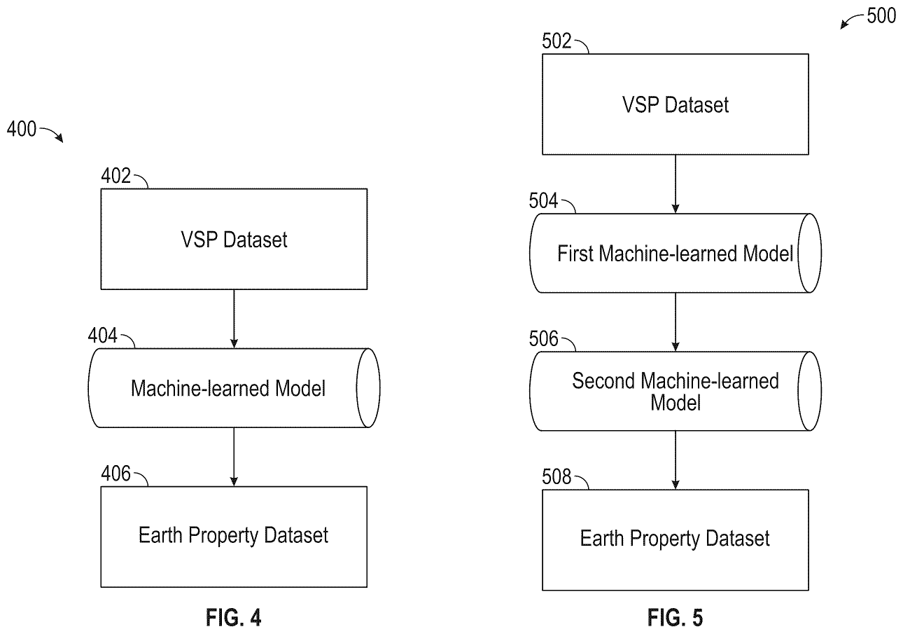

FIG. 4 depicts a high-level overview (400) of the process. First, a field vertical seismic profiling (VSP) dataset is acquired from a region of interest, where the region of interest comprises a set of at least one well. The field VSP dataset (402) may have undergone pre-processing (or processing) steps known in the art. This includes generating a corridor stack.

The field VSP dataset (402) is processed with a machine-learned model (404). The machine-learned model (404), and the data used to train it, will be described in greater detail later in the instant disclosure. However, for now, it is stated that the machine-learned model (404) is configured to receive the field VSP dataset (402) and, upon processing, output one or more earth properties referenced herein as an earth property dataset (406). In an embodiment, the earth properties dataset (406) is the earth properties in an undrilled portion of the region of interest (e.g., “ahead” of the drill bit).

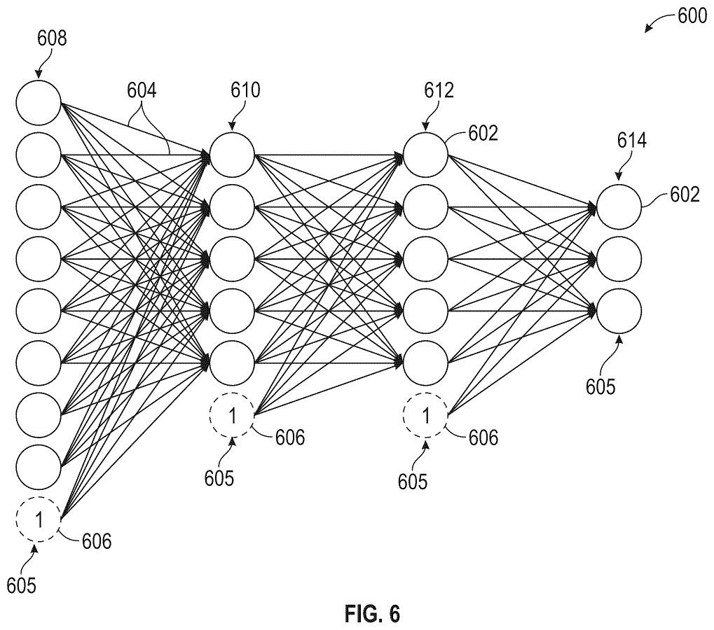

FIG. 5 depicts a high-level overview of the process (500) according to an alternate embodiment using a first machine learning model and a second machine learning model. First, a field vertical seismic profiling (VSP) dataset is acquired from a region of interest, where the region of interest comprises a set of at least one well. The field VSP dataset (502) may have undergone pre-processing (or processing) steps known in the art. This includes generating a corridor stack.

The field VSP dataset (502) is processed with a first machine-learned model (504). The first machine-learned model (504), and the data used to train it, will be described in greater detail later in the instant disclosure. However, for now, it is stated that the first machine-learned model (504) is configured to receive the field VSP dataset (502) and, upon processing, output a denoised VSP dataset.

The denoised VSP dataset is then processed with a second machine-learned model (506). The second machine-learned model (506), and the data used to train it, will be described in greater detail later in the instant disclosure. However, for now, it is stated that the second machine-learned model (506) is configured to receive the denoised VSP dataset from the first machine-learned model (504) and, upon processing, output one or more earth properties referenced herein as an earth property dataset (508). In an embodiment, the earth properties dataset (508) is the earth properties in an undrilled portion of the region of interest (e.g., “ahead” of the drill bit).

Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein. However, one skilled in the art will recognize that the concepts and methods detailed hereafter are not limited by this choice of nomenclature.

Machine-learned model types may include, but are not limited to, generalized linear models, Bayesian regression, random forests, and deep models such as neural networks, convolutional neural networks, and recurrent neural networks. Machine-learned model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. It is noted that in the context of machine learning (ML), the regularization of a machine-learned model refers to a penalty applied to the loss function of the machine-learned model and should not be confused with the regularization of a seismic dataset. Commonly, in the literature, the selection of hyperparameters surrounding a machine-learned model is referred to as selecting the model “architecture.” Once a machine-learned model type and hyperparameters have been selected, the machine-learned model is trained to perform a task. In accordance with one or more embodiments, a machine-learned model type and associated architecture are selected, the machine-learned model is trained to invert a VSP dataset so as to provide an earth property dataset, the performance of the machine-learned model is evaluated, and the machine-learned model is used in a production setting (also known as deployment of the machine-learned model).

As noted, the objective of the machine-learned model is to invert a VSP dataset to an earth property dataset. In accordance with one or more embodiments, the selected machine-learned model (404) type is a convolutional neural network (CNN). A CNN may be more readily understood as a specialized neural network (NN). Thus, a cursory introduction to a NN and a CNN are provided herein. However, it is noted that many variations of a NN and CNN exist. Therefore, one with ordinary skill in the art will recognize that any variation of the NN or CNN (or any other machine-learned model) may be employed without departing from the scope of this disclosure. Further, it is emphasized that the following discussions of a NN and a CNN are basic summaries and should not be considered limiting. In an embodiment, the CNN is a temporal convolutional network (TCN) or a combination or a CNN and a TCN. A TCN can be considered as a variation of a CNNs specialized for time series problems.

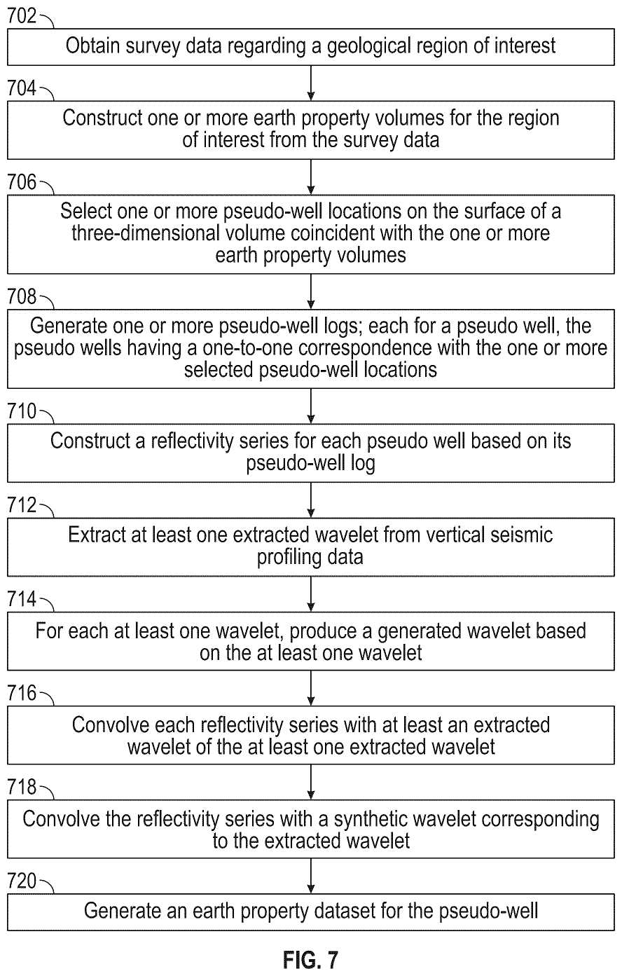

A diagram of a neural network is shown in FIG. 6. At a high level, a neural network (600) may be graphically depicted as being composed of nodes (602), where here any circle represents a node, and edges (604), shown here as directed lines. The nodes (602) may be grouped to form layers (605). FIG. 6 displays four layers (608, 610, 612, 614) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A neural network (600) will have at least two layers (605), where the first layer (608) is considered the “input layer” and the last layer (614) is the “output layer.” Any intermediate layer (610, 612) is usually described as a “hidden layer.” A neural network (600) may have zero or more hidden layers (610, 612) and a neural network (600) with at least one hidden layer (610, 612) may be described as a “deep” neural network or as a “deep learning method.” In general, a neural network (600) may have more than one node (602) in the output layer (614). In this case the neural network (600) may be referred to as a “multi-target” or “multi-output” network.

Nodes (602) and edges (604) carry additional associations. Namely, every edge is associated with a numerical value. The edge numerical values, or even the edges (604) themselves, are often referred to as “weights” or “parameters.” While training a neural network (600), numerical values are assigned to each edge (604). Additionally, every node (602) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ 1$$

where i is an index that spans the set of “incoming” nodes (602) and edges (604) and ƒ is a user-defined function. Incoming nodes (602) are those that, when viewed as a graph (as in FIG. 6), have directed arrows that point to the node (602) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (602) in a neural network (600) may have a different associated activation function. Often, as a shorthand, activation functions are described by the function ƒ by which it is composed. That is, an activation function composed of a linear function ƒ may simply be referred to as a linear activation function without undue ambiguity.

When the neural network (600) receives an input, the input is propagated through the network according to the activation functions and incoming node (602) values and edge (604) values to compute a value for each node (602). That is, the numerical value for each node (602) may change for each received input. Occasionally, nodes (602) are assigned fixed numerical values, such as the value of 1, that are not affected by the input or altered according to edge (604) values and activation functions. Fixed nodes (602) are often referred to as “biases” or “bias nodes” (606), displayed in FIG. 6 with a dashed circle.

In some implementations, the neural network (600) may contain specialized layers (605), such as a normalization layer, or additional connection procedures, like concatenation. One skilled in the art will appreciate that these alterations do not exceed the scope of this disclosure.

As noted, the training procedure for the neural network (600) comprises assigning values to the edges (604). To begin training the edges (604) are assigned initial values. These values may be assigned randomly, assigned according to a prescribed distribution, assigned manually, or by some other assignment mechanism. Once edge (604) values have been initialized, the neural network (600) may act as a function, such that it may receive inputs and produce an output. As such, at least one input is propagated through the neural network (600) to produce an output. Training data is provided to the neural network (600). Generally, training data consists of pairs of inputs and associated targets. The targets represent the “ground truth,” or the otherwise desired output, upon processing the inputs. During training, the neural network (600) processes at least one input from the training data and produces at least one output. Each neural network (600) output is compared to its associated input data target. The comparison of the neural network (600) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (600) output and the associated target. The loss function may also be constructed to impose additional constraints on the values assumed by the edges (604), for example, by adding a penalty term, which may be physics-based, or a regularization term (not be confused with regularization of seismic data). Generally, the goal of a training procedure is to alter the edge (604) values to promote similarity between the neural network (600) output and associated target over the training data. Thus, the loss function is used to guide changes made to the edge (604) values, typically through a process called “backpropagation.”

While a full review of the backpropagation process exceeds the scope of this disclosure, a brief summary is provided. Backpropagation consists of computing the gradient of the loss function over the edge (604) values. The gradient indicates the direction of change in the edge (604) values that results in the greatest change to the loss function. Because the gradient is local to the current edge (604) values, the edge (604) values are typically updated by a “step” in the direction indicated by the gradient. The step size is often referred to as the “learning rate” and need not remain fixed during the training process. Additionally, the step size and direction may be informed by previously seen edge (604) values or previously computed gradients. Such methods for determining the step direction are usually referred to as “momentum” based methods.

Once the edge (604) values have been updated, or altered from their initial values, through a backpropagation step, the neural network (600) will likely produce different outputs. Thus, the procedure of propagating at least one input through the neural network (600), comparing the neural network (600) output with the associated target with a loss function, computing the gradient of the loss function with respect to the edge (604) values, and updating the edge (604) values with a step guided by the gradient, is repeated until a termination criterion is reached. Common termination criteria are: reaching a fixed number of edge (604) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (604) values are no longer intended to be altered, the neural network (600) is said to be “trained.”

A CNN is similar to a neural network (600) in that it can technically be graphically represented by a series of edges (604) and nodes (602) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. Images have such a structural relationship. A seismic dataset may be organized and visualized as an image. Consequently, a CNN is an intuitive choice for processing a seismic dataset.

A structural grouping, or group, of weights is herein referred to as a “filter.” The number of weights in a filter is typically much less than the number of inputs, where here the number of inputs refers to the number of pixels in an image or the number of trace-time (or trace-depth) values in a seismic dataset. In a CNN, the filters can be thought as “sliding” over, or convolving with, the inputs to form an intermediate output or intermediate representation of the inputs which still possesses a structural relationship. Like unto the neural network (600), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (600) to produce a final output. Note, that in this context, the neural network (600) is still considered part of the CNN. Like unto a neural network (600), a CNN is trained, after initialization of the filter weights, and the edge (604) values of the internal neural network (600), if present, with the backpropagation process in accordance with a loss function.

To train the machine-learned model (404), training data must be provided. In general, collecting training data through many vertical seismic profiling surveys is a costly process. Further, as real vertical seismic profiling datasets are restricted to wellbores in the region of interest, they do not provide measurements for undrilled formation.

In contrast, in one or more embodiments of the instant disclosure, synthetic training data is generated for pseudo-wells (undrilled formations) directly from real acquired well logs and VSP data. Training data generated in this manner generalizes, standardizes, streamlines, and improves VSP corridor stack inversion results. Thus, allowing for a more widespread use of the results as it can be performed on a much larger scale.

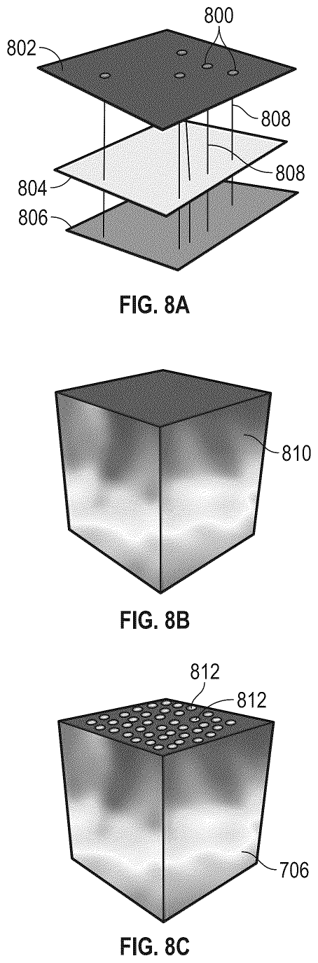

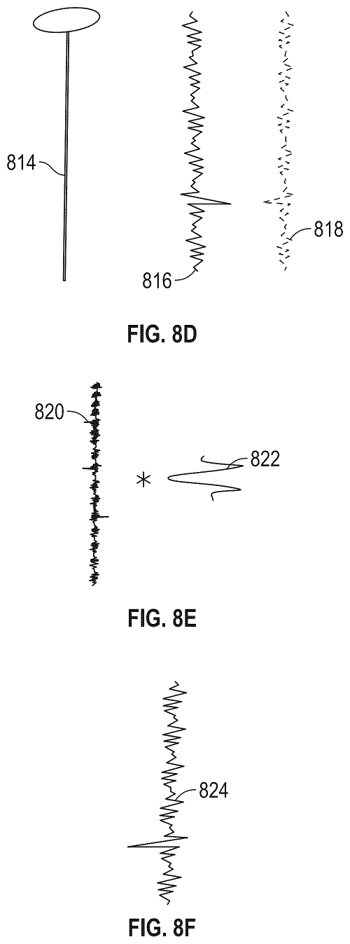

In accordance with one or more embodiments, FIG. 7 depicts a flowchart outlining the synthetic dataset generation process. FIG. 8A-FIG. 8F provide graphical illustrations of select steps to provide greater clarity. As seen in FIG. 7, in Block 702, a survey dataset is acquired from a region of interest. In accordance with one or more embodiments, the survey data includes one or more of tops, well logs and VSP data from one or more drilled wells in the region of interest, and horizon locations. As such, the region of interest may be a section of an oilfield comprising a set of drilled wells and at least one undrilled section, where the set of drilled wells includes at least one drilled well.

As stated, the survey data includes at least one well log associated with the set of drilled wells. The well log data may correspond to logging-while-drilling (LWD) measurements or measurement-while-drilling (MWD) measurements acquired from wellbores of the set of drilled wells. Alternatively, the well log data may correspond to a post-drilling logging performed on an already drilled well. The well log data may be obtained from a logging system that may include one or more logging tools for use in generating well logs of the formation. For example, a logging tool may be lowered into the wellbore of each well to acquire measurements as the tool traverses a depth interval of the wellbore. The plot of the logging measurements versus depth may be referred to as a “log” or “well log.”

Well logs may provide depth measurements of the well that describe such reservoir characteristics as formation porosity, formation permeability, resistivity, density, water saturation, and the like. The well log may be a sonar log, providing velocity measurements. For example, acoustic waves may travel faster through high-density shales than through lower-density sandstones. The well log may be a density log. Density logging may determine density measurements or porosity measurements by directly measuring the density of the rocks in the formation. In accordance with one or more embodiments, a well log from a drilled well includes a sonic log and a density log. Further, for a given well, the sonic log and the density log can be used to form an acoustic impedance log, where the acoustic impedance is the product of the density and velocity at each depth. Further, for a given well, the acoustic impedance log can be used to form a reflectivity series log.

The survey data further includes VSP data for the set of drilled wells in the region of interest. The VSP data may comprise seismic traces. In one or more embodiments, the VSP data is in the form of a corridor stack.

In accordance with an embodiment, the survey dataset further comprises horizon data and top data. A top refers to a geological formation top (upper boundary). Usually, this is in a 1D sense and is in reference to wellbore markers. Horizons are planes that illustrate the geological formation boundary in a 2D sense. FIG. 8A shows the surface locations of the wells (800) in a region of interest, three horizons (802, 804, and 806) representing three formations, and wellbores (808). The intersections between the wellbores (808) and the horizons (802, 804, 806) are the tops of each of the three formations. The tops data and the horizons data may be obtained from surface seismic data in the region of interest.

As will be discussed with reference to Block 704 to Block 720 of FIG. 7, the survey dataset is augmented to provide a larger augmented dataset. The augmented dataset comprises pseudo-well data. Pseudo-well data represents well data expected to be acquired from a well if that well were drilled. In other words, pseudo-well data is associated with a virtual well, or “pseudo well,” in the region of interest. In an embodiment, a number of pseudo-wells in the region of interest is greater than a number of drilled wells in the region of interest. In this way an augmented dataset can be obtained with which to train a machine-learned model.

Continuing with FIG. 7, in Block 704 the survey data is used to construct one or more earth property volumes. An earth property volume is a representation of an earth property such as velocity, density, permeability, impedance, or the like, over a three-dimensional space corresponding to a subsurface volume in the region of interest. In an embodiment, the three-dimensional volume represents the region of interest. In accordance with one or more embodiments, the one or more earth property volumes are constructed via interpolation of survey data. For example, FIG. 8A depicts the surface locations of the wells (800) of multiple wellbores (808) as well as the path of the wellbores (808) through subsurface. Each wellbore can have associated well data such as density and sonic logs. As such, the density log from the wellbores (808) can be interpolated to construct a three-dimensional density volume corresponding with the region of interest. Similarly, a sonic log from each of the wellbores (808) can be used to construct a three-dimensional velocity volume corresponding with the region of interest. FIG. 8B illustrates an interpolated three-dimensional volume (810) representing the region of interest in FIG. 8A. The interpolated volume may be, for example, a density volume or velocity volume.

In accordance with one or more embodiments the one or more earth property volumes include a first set of earth property volumes that include earth properties desired to be predicted (e.g., ahead of a drill bit) using the machine-learned model based on VSP data. The one or more earth property volumes further includes a second set of earth property volumes that can be used to generate a reflectivity series at a location of a pseudo-well, as will be described below. For example, a density volume and a velocity volume can be used to determine an impedance, and subsequently, a reflectivity series associated with a pseudo-well. In other embodiments, an impedance volume or even a reflectivity volume can be constructed from which a reflectivity series can be generated at a location of a pseudo-well. It is noted that the first set of earth property volumes and the second set of earth property volumes need not be distinct nor disjoint. In practice, the one or more earth property volumes that include earth properties desired for prediction (i.e., the first set) and the one or more earth property logs used to generate a reflectivity series at a location of a pseudo-well (i.e., the second set) can be the same. For example, the one or more constructed earth property volumes can include a density volume and a velocity volume where these properties are both desirable as outputs of the ML model and can be used to form a reflectivity series at a location of a pseudo-well. As such, in this example, the first set of earth property models and the second set of earth property models are the same.

Any interpolation method that can honor the known horizon data may be used. That is, in accordance with one or more embodiments, the interpolation method is suitable for following the horizons associated with the region of interest (the geological formation). For example, a Kriging interpolation method.

In an embodiment, the survey dataset comprises horizon data and/or top data and these are used to guide the interpolation of the well log velocities and densities. The horizons and tops are used to provide bounds and give structural element to the interpolation.

In Block 706, one or more location points, representing a pseudo-well location, are selected on the surface of a three-dimensional volume coincident with the one or more interpolated earth property volumes. This is further illustrated in FIG. 8C, which shows pseudo-well locations (812). In the case of both velocity and density volumes having been generated, then a location point, representing the pseudo-well, is located on the surface of the interpolated velocity volume, and a corresponding location point is selected on the surface of the density volume.

In Block 708 of FIG. 7, a pseudo-well log is generated for each pseudo-well represented by the one or more selected location points. In an embodiment, a first vertical line (a simulated or virtual wellbore) is extended from a pseudo-well location (812) point on the surface of the interpolated velocity volume and traverses down into the interpolated velocity volume. Values of velocity along this line versus depth provide a pseudo-well velocity well log. A second vertical line is extended from the pseudo-well location (812) point on the surface of the interpolated density volume and traverses into the interpolated density volume. Values of density along this line versus depth provide a pseudo-well density well log.

As an example, FIG. 8D shows a pseudo-well (814) and the pseudo-well velocity well log (816) and the pseudo-well density well log (818) that have been determined from the interpolated velocity and density volumes respectively.

In Block 710 of FIG. 7, a reflectivity series is generated from the pseudo-well logs for each of the one or more pseudo-wells. In an embodiment, for a given pseudo-well with a pseudo-well velocity log and a pseudo-well density log, the pseudo-well velocity log and the pseudo-well density log are converted into an acoustic impedance well log, where the acoustic impedance at a given depth in the pseudo-well is the product of the velocity and the density at that depth. A reflectivity series for the given pseudo-well is then constructed as difference in acoustic impedance with respect to depth (also referred to as a depthwise difference in impedance). This process can be applied to any pseudo-well with a pseudo-well log that includes both density and velocity to construct a reflectivity series for each of the pseudo-wells. In other embodiments, an impedance volume is constructed in Block 704. Thus, a pseudo-well log can be generated at a selected pseudo-well location by extending a vertical line from the surface location of the pseudo-well through impedance volume to generate an impedance log for the pseudo-well and then constructing a reflectivity series from the impedance log. In other embodiments, a reflectivity volume is constructed in Block 704. In these instances, a reflectivity series for a pseudo-well is constructed by extending a vertical line from the surface location of the pseudo-well through the reflectivity volume.

In Block 712 of FIG. 7, at least one extracted wavelet is extracted from the VSP data. In an embodiment, for each well with VSP data, a wavelet is extracted from the VSP data. In an embodiment, the wavelet is extracted from corridor stack data. In a further embodiment, if the VSP data is not a corridor stack, it is first converted to a corridor stack. The wavelet may be extracted by either deterministic or statistical approaches from the corridor stack. Deterministically, it can be extracted from the P-wave down going wavefield in VSP data. Statistically, the wavelet can be directly extracted from the corridor stack from a power spectrum of the corridor stack data and by assuming the phase of the wavelet. In an embodiment, the phase of the wavelet is assumed to be zero, which is a valid assumption for VSP data.

In Block 714 of FIG. 7, for each extracted wavelet, a generated wavelet is produced that closely resembles the extracted wavelet shape and frequency content. This creates an extracted-generated wavelet pair. The generated wavelet may be produced based on knowing what the source that generated the VSP data was. For example, for a Vibroseis source, a Klauder wavelet may be generated. For an air-gun source, a Ricker wavelet may be generated. However, other wavelets may be generated. In a further embodiment, the configurations of the source are known (for example the sweep frequency for the Vibroseis, the length of the sweep) and these are adjusted to create the synthetic wavelet that best matches the extracted wavelet, for Air-guns as an example.

In Block 716 of FIG. 7, for each pseudo-well, the reflectivity series is convolved with at least one extracted wavelet to create a first input. For example, an extracted wavelet may be chosen randomly from all the extracted wavelets. Alternatively, an extracted wavelet may be chosen based on the proximity of the pseudo-well to the well associated with the extracted wavelet. For a given pseudo-well, the convolution of its reflectivity series and an extracted wavelet is said to result in an extracted seismic dataset (also referred to as a first synthetic seismic dataset) for that pseudo-well. Synthetic seismic data comprises the one or more extracted seismic datasets for each pseudo-well.

In Block 718 of FIG. 7, in accordance with one or more embodiments, for each pseudo-well its reflectivity series is convolved with at least one generated wavelet corresponding to the at least one extracted wavelet of Block 716. For a given pseudo-well, the convolution of its reflectivity series and a generated wavelet is said to result in a generated seismic dataset for that pseudo-well (also referred to as a second synthetic seismic dataset). Synthetic seismic data further comprises the one or more generated seismic datasets for each pseudo-well. Each generated synthetic seismic dataset represents a synthetic seismic dataset with reduced noise relative to the associated extracted synthetic seismic dataset generated in Block 716.

Thus, Blocks 716 and 718 form synthetic seismic data, the synthetic seismic data including at least one extracted seismic dataset and corresponding generated seismic dataset for each of the one or more pseudo-wells.

FIG. 8E illustrates a reflectivity series (820) and a wavelet (822), where the wavelet may be an extracted wavelet or its corresponding synthetic wavelet. The convolution (*) of the wavelet with the reflectivity series results in the synthetic seismic data (824) of FIG. 8D. In an embodiment, the synthetic seismic data (824) is a corridor stack.

In Block 720 of FIG. 7, for each pseudo-well, target data representing at least one earth property is generated. In accordance with one or more embodiments the target data for each pseudo-well is based on the first set of earth property volumes that include earth properties desired to be predicted using the machine-learned model based on VSP data. In one or more embodiments, the target data for a pseudo-well is formed, similar to the construction of the well logs, by traversing a vertical line from the surface location of the pseudo well through the constructed (i.e., interpolated) volume representing the earth property of interest. That is, the target data is a pseudo-well log for a desired earth property, or an earth property of interest. For example, the pseudo-well density logs may be the target data for the pseudo-wells. Thus, the synthetic seismic data associated with a pseudo-well (e.g., an extracted seismic dataset) can be related to the target data, or a desired earth property log, of that pseudo-well. In some embodiments, the target data includes only desired earth property data for a pseudo-well below (i.e., deeper) than a given depth. In these embodiments, the synthetic seismic data for pseudo well may be truncated to only include depths above (i.e., shallower) than the given depth. In this way, the synthetic seismic data of a given pseudo-well simulated as drilled to a given depth can be related to an earth property (or earth property data) at depths greater than (or deeper than) the given depth.

While the various blocks in FIG. 7 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Products of the processes described with respect to FIG. 7 include synthetic seismic data and target data for one or more pseudo-wells. Further, the synthetic seismic data includes both at least one extracted seismic dataset and associated generated seismic dataset corresponding to whether a convolution with the reflectivity series of the pseudo-well was performed with an extracted or generated wavelet. Thus, for a given pseudo-well, there exists at least one extracted seismic dataset and corresponding generated seismic dataset, and target data. The synthetic seismic data and target data can be used to train one or more machine-learned models.

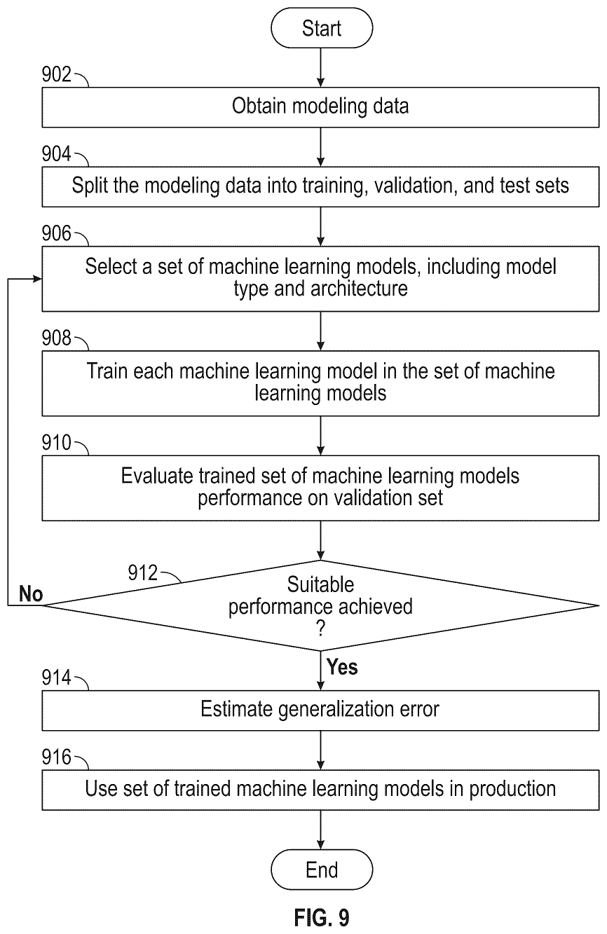

FIG. 9 depicts a flowchart for training one or more machine-learned models, in accordance with one or more embodiments. In Block 902, modelling data is obtained. In accordance with one or more embodiments, the modelling data consists of one or more input-target pairs, where for a given pair, the target represents the desired output of a machine-learned model operating on the input. Thus, in the context of the instant disclosure, the modelling data can include the synthetic seismic data and the target data of one or more pseudo-wells, where these data items are developed according to the processes of FIG. 7.

In Block 904, the modelling data is split into a training set, validation set, and test set. In one or more embodiments, the validation and the test set are the same such that the modelling data is effectively split into a training set and a validation/test set. In an embodiment, the training set comprises data generated for pseudo-well, such as the synthetic seismic dataset and the target data of one or more of the pseudo-wells, using the process outlined in FIG. 7. In an embodiment, the validation set is the data (well log and vertical seismic profiling data) associated with the set of drilled wells in the geological region of interest that was used to generate the three-dimensional volumes (earth property volumes) as outlined with respect to Block 704 of FIG. 7. In an embodiment, the test set is data (well log and vertical seismic profiling data) from drilled wells within the geological region of interest that were not used, or were omitted, to generate the three-dimensional volumes (earth property volumes) as outlined with respect to Block 704 of FIG. 7.

In Block 906, a set of machine-learned models is selected, including a machine-learned model type (e.g., a CNN) and an architecture (e.g., number of layers, kernel sizes, activation functions) of each machine-learned model in the set of machine learning models. In an embodiment, the set of machine learning models comprises a single machine-learned model (404), such as illustrated in the embodiment of FIG. 4. In an embodiment, the set of machine-learning models comprises a first machine-learned model (504) and a second machine learned model (506) as illustrated in the embodiment of FIG. 5. In accordance with one or more embodiments, multiple machine-learned model types and architectures are evaluated to discover the model with the best performance. In accordance with one or more embodiments, the selection of the machine-learned model type and architecture is performed by cycling through a set of user-defined models and associated architectures. In other embodiments, the machine-learned model type and architecture are selected based on the performance of previous models, for example, using a Bayesian-based search. In Block 908, the set of machine learning models is trained using the training set. In the embodiment where the set of machine learning models comprises a single machine-learned model (404), such as illustrated in the embodiment of FIG. 4, the training data comprises input-target pairs where the extracted seismic data (or first synthetic seismic data) is the input and the target data for each pseudo-well is the target. In the embodiment where the set of machine-learning models comprises a first machine-learned model (504) and a second machine learned model (506), as illustrated in the embodiment of FIG. 5, the training data comprises a first training data for the first machine-learned model (504) and a second training data for the second machine-learned model (506), where both the first training data and the second training data comprise input-target pairs. The first training data comprises the extracted synthetic seismic data (or first synthetic seismic data) as the input and the generated synthetic seismic data (or second synthetic seismic data) as the target for the first machine-learned model. The second training data comprises the generated synthetic seismic data (or second synthetic seismic data) as the input and the target data for each pseudo-well as the target for the second machine-learned model. Alternatively, the second training data comprises an output of the first machine-learned model as the input and the target data for each pseudo-well as the target for the second machine-learned model.

Each machine-learned model of the set of machine learning models processes an input from an input-target pair of the training data and produces an output. The output is compared to the target. During training, each machine-learned model is adjusted such that the output of the machine-learned model is similar to the target.

In an embodiment where the set of machine learning models comprises a first machine-learned model and a second machine-learned model, the second machine-learned model is trained independently of the first machine-learned model. The first machine-learned model processes the first synthetic seismic data and produces an output that is compared to the second synthetic seismic data, and the first machine-learned model is adjusted accordingly. The second machine-learned model processes the second synthetic seismic data and produces an output that is compared to the target data for each pseudo-well, and the second machine-learned model is adjusted accordingly. In an alternative embodiment, the second machine-learned model is trained in conjunction with the trained first machine-learned model. The trained first machine-learned model processes the first synthetic seismic data and produces an output. The second machine-learned model processes the output of the trained first machine-learned model and produces an output that is compared to the target data for each pseudo-well, and the second machine-learned model is adjusted accordingly.

Once each machine-learned model of the set of machine learning models is trained, in Block 910, the input-target pairs of the validation set are processed by the trained set of machine learning models, where the extracted synthetic seismic data (or first synthetic seismic data) is the input and the target data for each pseudo-well is the target. The output of the set of machine learning models is compared to the target data for each pseudo-well. Thus, the performance of the trained set of machine learning models can be evaluated. In the embodiment where the set of machine-learning models comprises a first machine-learned model (504) and a second machine learned model (506) as illustrated in FIG. 5, the set of machine learning models may be evaluated in combination (as a whole) by using the extracted synthetic seismic data (or first synthetic seismic data) of the input-target pair of the validation set as the input to the first machine-learned model, using the output of the first machine learned model as the input to the second machine learned model, and comparing the output of the second machine-learned model to the target of the input-targe pair of the validation set. Alternatively, the first machine learned-model and the second machine-learned model may be validated independently.

Block 912 represents a decision. If the trained set of machine learning models is found to have suitable performance as evaluated on the validation set, where the criterion for suitable performance is defined by a user, then the trained set of machine learning models is accepted for use on new seismic datasets. When the set of machine learning models is used on non-synthetic seismic datasets where the use of the set of machine learning models provides for inversion of VSP data to provide earth properties, the set of machine learning models is said to be used in production. In Block 916, the trained machine-learned model is used in production. However, before the machine-learned model is used in production a final indication of its performance can be acquired by estimating the generalization error of the trained machine-learned model, as shown in Block 914. The generalization error is estimated by evaluating the performance of the trained set of machine learning models, after a suitable model has been found, on the test set. One with ordinary skill in the art will recognize that the training procedure depicted in FIG. 9 is general and that many adaptions can be made without departing from the scope of the present disclosure. For example, common training techniques, such as early stopping, adaptive or scheduled learning rates, and cross-validation may be used during training without departing from the scope of this disclosure.

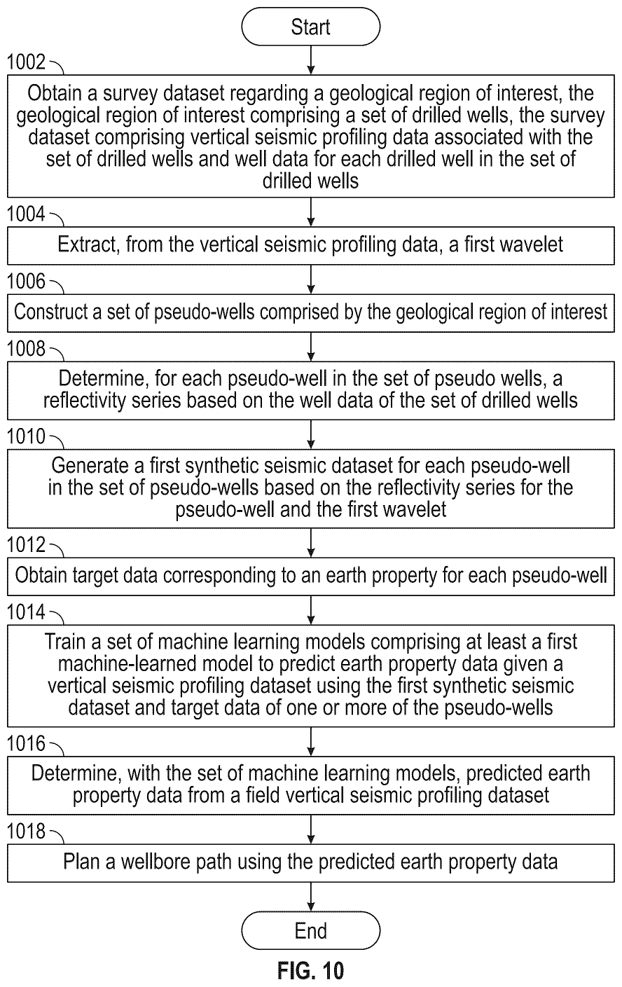

FIG. 10 depicts a flowchart outlining the process of training and using a machine-learned model to provide inversion of vertical seismic profiling data and provide an earth property dataset. In Block 1002, a survey dataset regarding a geological region of interest is obtained. The geological region of interest comprises a set of drilled wells, and the survey dataset comprises vertical seismic profiling data associated with the set of drilled wells and well data for each drilled well in the set of drilled wells. The vertical seismic profiling data (VSP) data may resemble that shown in FIG. 3. It is noted that once acquired, the VSP data may undergo a myriad of pre-processing steps. One with ordinary skill in the art will recognize that zero or more pre-processing (or processing) steps may be applied with the methods disclosed herein without imposing a limitation on the instant disclosure. In Block 1004, a first wavelet is extracted from the vertical seismic profiling data. One with ordinary skill in the art will recognize that a number of wavelet extraction methods may be used. In Block 1006, a set of pseudo-wells comprised by the geological region of interest is constructed. In Block 1008, for each pseudo-well in the set of pseudo wells, a reflectivity series based on the well data of the set of drilled wells is determined. In Block 1010, a first synthetic seismic dataset for each pseudo-well in the set of pseudo-wells is generated based on the reflectivity series for the pseudo-well and the first wavelet. In Block 1012, target data corresponding to an earth property for each pseudo-well is obtained. Thus, an input-target pair may be generated that may be used for training a machine-learned model. In Block 1014 a set of machine learning models comprising at least a first machine-learned model is trained to predict earth property data given a vertical seismic profiling dataset using the first synthetic seismic dataset and target data of one or more of the pseudo-wells. In Block 1016 predicted earth property data are determined, with the set of machine learning models, from a field vertical seismic profiling dataset. In Block 1018, a wellbore path is planned using the predicted earth property data.

The present disclosure generates synthetic seismic data to train a machine-learned model to invert vertical seismic profiling data so as to provide an earth property dataset. By generating synthetic data, it enables the machine-learned model to be trained on a big data set representing undrilled formations in the region of interest. The use of such a synthetic seismic dataset generalizes, standardizes, streamlines, and improves VSP corridor stack inversion results. This allows for a more widespread use of the results, or earth properties, as it can be performed on a much larger scale.

Due to the training on a large synthetic dataset, the deployment of the machine-learned model will provide more accuracy in determining earth properties, such as 1D velocity and depth to undrilled targets at well locations with VSP data. The improved results would provide more accurate depth prognosis to target which in turn would allow for better decision making of whether to pursue this target.

The output of such the trained machine-learned model also provides additional information to seismic depth imaging (higher quality velocity profiles in undrilled/deeper targets), thus allowing for better 3D Earth property models. The improved 3D models would allow for better interpretation of the area providing additional opportunities for exploration, delineation and development.

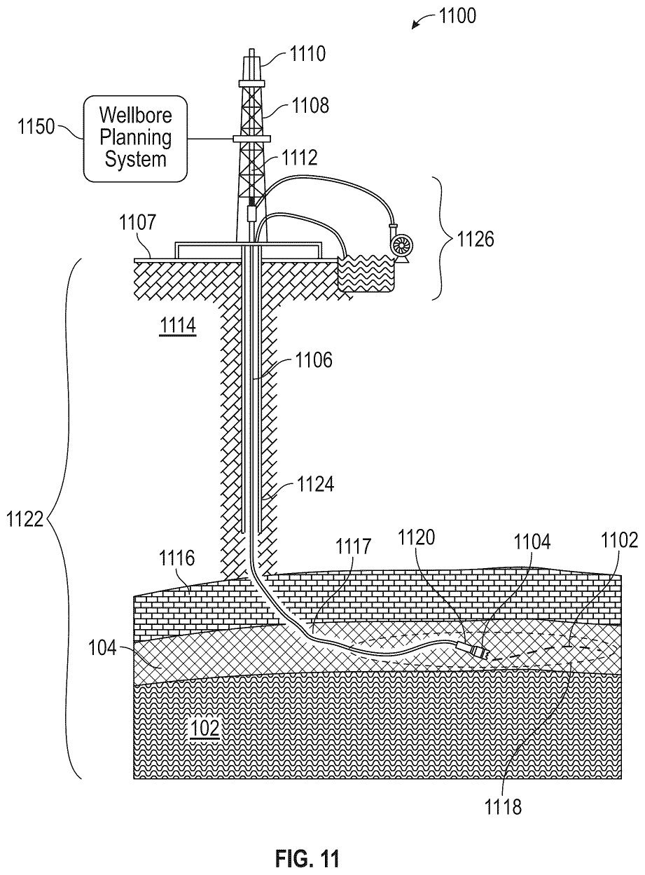

FIG. 11 shows a drilling system (1100) in accordance with one or more embodiments. Although the drilling system (1100) shown in FIG. 11 is used to drill a wellbore on land, the drilling system (1100) may also be a marine wellbore drilling system. The example of the drilling system (1100) shown in FIG. 11 is not meant to limit the present disclosure.

As shown in FIG. 11, a wellbore path (1102) may be drilled by a drill bit (1104) attached by a drillstring (1106) to a drill rig located on the surface (1107) of the earth. The drill rig may include framework, such as a derrick (1108) to hold drilling machinery. The top drive (1110) sits at the top of the derrick (1108) and provides torque, typically a clockwise torque, via the drive shaft (1112) to the drillstring (1106) in order to drill the wellbore. The wellbore may traverse a plurality of overburden (1114) layers and one or more cap-rock (1116) layers to a hydrocarbon reservoir (104) within the subterranean region of interest (102). In accordance with one or more embodiments, the field earth property dataset may be used to plan a wellbore including a wellbore path (1102) and drill a wellbore (1117) guided by the wellbore path (1102). The wellbore path (1102) may be a curved wellbore path, or a straight wellbore path. All or part of the wellbore path (1102) may be vertical, and some wellbore paths may be deviated or have horizontal sections.

Prior to the commencement of drilling, a wellbore plan may be generated. The wellbore plan may include a starting surface location of the wellbore, or a subsurface location within an existing wellbore, from which the wellbore may be drilled. Further, the wellbore plan may include a terminal location that may intersect with the target zone (1118), e.g., a targeted hydrocarbon-bearing formation, and a planned wellbore path (1102) from the starting location to the terminal location. In other words, the wellbore path (1102) may intersect a previously located hydrocarbon reservoir (104).

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. In accordance with one or more embodiments, the wellbore plan is informed by a field earth property dataset produced using the machine-learned model (404) applied to a VSP dataset (402) acquired through a survey conducted in the subterranean region of interest.

The wellbore plan may include wellbore geometry information such as wellbore diameter and inclination angle. If casing (1124) is used, the wellbore plan may include casing type or casing depths. Furthermore, the wellbore plan may consider other engineering constraints such as the maximum wellbore curvature (“dog-log”) that the drillstring (1106) may tolerate and the maximum torque and drag values that the drilling system (1100) may tolerate.

A wellbore planning system (1150) may be used to generate the wellbore plan. The wellbore planning system (1150) may comprise one or more computer processors in communication with computer memory containing the geophysical and geomechanical models, the field earth property dataset, information relating to drilling hazards, and the constraints imposed by the limitations of the drillstring (1106) and the drilling system (1100). The wellbore planning system (1150) may further include dedicated software to determine the planned wellbore path (1102) and associated drilling parameters, such as the planned wellbore diameter, the location of planned changes of the wellbore diameter, the planned depths at which casing (1124) will be inserted to support the wellbore and to prevent formation fluids entering the wellbore, and the drilling mud weights (densities) and types that may be used during drilling the wellbore.

A wellbore (1117) may be drilled using a drill rig that may be situated on a land drill site, an offshore platform, such as a jack-up rig, a semi-submersible, or a drill ship. The drill rig may be equipped with a hoisting system, such as a derrick (1108), which can raise or lower the drillstring (1106) and other tools required to drill the well. The drillstring (1106) may include one or more drill pipes connected to form conduit and a bottom hole assembly (BHA) (1120) disposed at the distal end of the drillstring (1106). The BHA (1120) may include a drill bit (1104) to cut into subsurface (1122) rock. The BHA (1120) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit, the weight-on-bit, and the torque. The LWD measurements may include sensors, such as resistivity, gamma ray, and neutron density sensors, to characterize the rock formation surrounding the wellbore (1117). Both MWD and LWD measurements may be transmitted to the surface (1107) using any suitable telemetry system, such as mud-pulse or wired-drill pipe, known in the art.

To start drilling, or “spudding in” the well, the hoisting system lowers the drillstring (1106) suspended from the derrick (1108) towards the planned surface location of the wellbore (1117). An engine, such as a diesel engine, may be used to supply power to the top drive (1110) to rotate the drillstring (1106). The weight of the drillstring (1106) combined with the rotational motion enables the drill bit (1104) to bore the wellbore.

The near-surface is typically made up of loose or soft sediment or rock, so large diameter casing (1124), e.g., “base pipe” or “conductor casing,” is often put in place while drilling to stabilize and isolate the wellbore. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface (1107) of the earth.

Drilling may continue without any casing (1124) once deeper, or more compact rock is reached. While drilling, a drilling mud system (1126) may pump drilling mud from a mud tank on the surface (1107) through the drill pipe. Drilling mud serves various purposes, including pressure equalization, removal of rock cuttings, and drill bit cooling and lubrication.

At planned depth intervals, drilling may be paused and the drillstring (1106) withdrawn from the wellbore. Sections of casing (1124) may be connected and inserted and cemented into the wellbore. Casing string may be cemented in place by pumping cement and mud, separated by a “cementing plug,” from the surface (1107) through the drill pipe. The cementing plug and drilling mud force the cement through the drill pipe and into the annular space between the casing and the wellbore wall. Once the cement cures, drilling may recommence. The drilling process is often performed in several stages. Therefore, the drilling and casing cycle may be repeated more than once, depending on the depth of the wellbore and the pressure on the wellbore walls from surrounding rock.

Due to the high pressures experienced by deep wellbores, a blowout preventer (BOP) may be installed at the wellhead to protect the rig and environment from unplanned oil or gas releases. As the wellbore becomes deeper, both successively smaller drill bits and casing string may be used. Drilling deviated or horizontal wellbores may require specialized drill bits or drill assemblies.

A drilling system (1100) may be disposed at and communicate with other systems in the well environment. The drilling system (1100) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), 1114 and rate of penetration of the drilling operation (ROP). Each sensor may be positioned or configured to measure a desired physical stimulus. Drilling may be considered complete when a target zone (1118) is reached, or the presence of hydrocarbons is established.

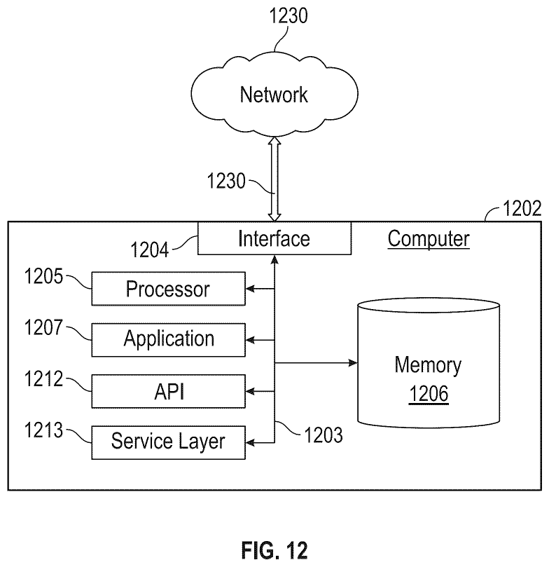

FIG. 12 further depicts a block diagram of a computer (1202) system used to provide computational functionalities associated with the methods, functions, processes, flows, and procedures as described in this disclosure, according to one or more embodiments. The illustrated computer (1202) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1202) may include a computer that includes an input device, such as a keypad, keyboard, touch screen, or other device that can accept user information, and an output device that conveys information associated with the operation of the computer (1202), including digital data, visual, or audio information (or a combination of information), or a GUI.

The computer (1202) can serve in a role as a client, network component, a server, a database or other persistency, or any other component (or a combination of roles) of a computer system for performing the subject matter described in the instant disclosure. In some implementations, one or more components of the computer (1202) may be configured to operate within environments, including cloud-computing-based, local, global, or other environment (or a combination of environments).

At a high level, the computer (1202) is an electronic computing device operable to receive, transmit, process, store, or manage data and information associated with the described subject matter. According to some implementations, the computer (1202) may also include or be communicably coupled with an application server, e-mail server, web server, caching server, streaming data server, business intelligence (BI) server, or other server (or a combination of servers).

The computer (1202) can receive requests over network (1230) from a client application (for example, executing on another computer (1202) and responding to the received requests by processing the said requests in an appropriate software application. In addition, requests may also be sent to the computer (1202) from internal users (for example, from a command console or by other appropriate access method), external or third-parties, other automated applications, as well as any other appropriate entities, individuals, systems, or computers.

Each of the components of the computer (1202) can communicate using a system bus (1203). In some implementations, any or all of the components of the computer (1202), both hardware or software (or a combination of hardware and software), may interface with each other or the interface (1204) (or a combination of both) over the system bus (1203) using an application programming interface (API) (1212) or a service layer (1213) (or a combination of the API (1212) and service layer (1213). The API (1212) may include specifications for routines, data structures, and object classes. The API (1212) may be either computer-language independent or dependent and refer to a complete interface, a single function, or even a set of APIs. The service layer (1213) provides software services to the computer (1202) or other components (whether or not illustrated) that are communicably coupled to the computer (1202). The functionality of the computer (1202) may be accessible for all service consumers using this service layer. Software services, such as those provided by the service layer (1213), provide reusable, defined business functionalities through a defined interface. For example, the interface may be software written in JAVA, C++, or other suitable language providing data in extensible markup language (XML) format or another suitable format. While illustrated as an integrated component of the computer (1202), alternative implementations may illustrate the API (1212) or the service layer (1213) as stand-alone components in relation to other components of the computer (1202) or other components (whether or not illustrated) that are communicably coupled to the computer (1202). Moreover, any or all parts of the API (1212) or the service layer (1213) may be implemented as child or sub-modules of another software module, enterprise application, or hardware module without departing from the scope of this disclosure.

The computer (1202) includes an interface (1204). Although illustrated as a single interface (1204) in FIG. 12, two or more interfaces (1204) may be used according to particular needs, desires, or particular implementations of the computer (1202). The interface (1204) is used by the computer (1202) for communicating with other systems in a distributed environment that are connected to the network (1230). Generally, the interface (1204) includes logic encoded in software or hardware (or a combination of software and hardware) and operable to communicate with the network (1230). More specifically, the interface (1204) may include software supporting one or more communication protocols associated with communications such that the network (1230) or interface's hardware is operable to communicate physical signals within and outside of the illustrated computer (1202).

The computer (1202) includes at least one computer processor (1205). Although illustrated as a single computer processor (1205) in FIG. 12, two or more processors may be used according to particular needs, desires, or particular implementations of the computer (1202). Generally, the computer processor (1205) executes instructions and manipulates data to perform the operations of the computer (1202) and any algorithms, methods, functions, processes, flows, and procedures as described in the instant disclosure.

The computer (1202) also includes a memory (1206) that holds data for the computer (1202) or other components (or a combination of both) that can be connected to the network (1230). The memory may be a non-transitory computer readable medium (also referred to as a non-transitory machine-readable medium). For example, memory (1206) can be a database storing data consistent with this disclosure. Although illustrated as a single memory (1206) in FIG. 12, two or more memories may be used according to particular needs, desires, or particular implementations of the computer (1202) and the described functionality. While memory (1206) is illustrated as an integral component of the computer (1202), in alternative implementations, memory (1206) can be external to the computer (1202).

The application (1207) is an algorithmic software engine providing functionality according to particular needs, desires, or particular implementations of the computer (1202), particularly with respect to functionality described in this disclosure. For example, application (1207) can serve as one or more components, modules, applications, etc. Further, although illustrated as a single application (1207), the application (1207) may be implemented as multiple applications (1207) on the computer (1202). In addition, although illustrated as integral to the computer (1202), in alternative implementations, the application (1207) can be external to the computer (1202).

There may be any number of computers (1202) associated with, or external to, a computer system containing computer (1202), wherein each computer (1202) communicates over network (1230). Further, the term “client,” “user,” and other appropriate terminology may be used interchangeably as appropriate without departing from the scope of this disclosure. Moreover, this disclosure contemplates that many users may use one computer (1202), or that one user may use multiple computers (1202).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a survey dataset regarding a geological region of interest, the geological region of interest comprising a set of drilled wells, the survey dataset comprising vertical seismic profiling data associated with the set of drilled wells and well data for each drilled well in the set of drilled wells;
extracting, from the vertical seismic profiling data, a first wavelet;
constructing a set of pseudo-wells comprised by the geological region of interest;
determining, for each pseudo-well in the set of pseudo-wells, a reflectivity series based on the well data of the set of drilled wells;
generating a first synthetic seismic dataset for each pseudo-well in the set of pseudo-wells based on the reflectivity series for that pseudo-well and the first wavelet;
obtaining target data corresponding to an earth property for each pseudo-well;
training a set of machine learning models comprising at least a first machine-learned model to predict earth property data given a vertical seismic profiling dataset using the first synthetic seismic dataset and target data of one or more of pseudo-wells in the set of pseudo-wells;
determining, with the set of machine learning models, predicted earth property data from a field vertical seismic profiling dataset; and
planning a wellbore path using the predicted earth property data.

2. The method of claim 1, further comprising:
determining a location of a hydrocarbon reservoir in the geological region of interest using the predicted earth property data; and
planning the wellbore path so as to cause a wellbore to penetrate the hydrocarbon reservoir based on the location.

3. The method of claim 2, further comprising:
drilling the wellbore guided by the planned wellbore path.

4. The method of claim 1, wherein the set of machine learning models further comprises a second machine-learned model, the method further comprising:
generating, based on the first wavelet, a second wavelet;
generating a second synthetic seismic dataset for each pseudo-well in the set of pseudo-wells based on the reflectivity series for that pseudo-well and the second wavelet; and
training the set of machine learning models to predict the earth property data using the first synthetic seismic dataset, the second synthetic seismic dataset and the target data of one or more of the pseudo-wells.

5. The method of claim 4, wherein the training the set of machine learning models comprises:
training the first machine-learned model using the first synthetic seismic dataset and the second synthetic seismic dataset; and
training the second machine-learned model using the second synthetic seismic dataset or an output of the first machine-learned model, and the target data of one or more of the pseudo-wells.

6. The method of claim 1, further comprising:
generating, using the well data, at least one three-dimensional volume for the geological region of interest;
generating, for each pseudo-well, a pseudo-well log by traversing the at least one three-dimensional volume; and
determining the reflectivity series using the pseudo-well log.

7. The method of claim 6, wherein the at least one three-dimensional volume comprises a density volume and a velocity volume, wherein determining the reflectivity series for each pseudo-well comprises:
determining a depthwise difference in impedance from an impedance log for each pseudo-well, wherein each impedance log is a depthwise product of a density log and a velocity log for each pseudo-well.

8. The method of claim 1, further comprising:
evaluating the set of machine learning models based on a validation set, wherein the validation set comprises the vertical seismic profiling data associated with the set of drilled wells and the well data for each drilled well in the set of drilled wells;
obtaining a test dataset from a well not included in the set of drilled wells, wherein the test dataset comprises vertical seismic data and well data for the well not included in the set of drilled wells; and
evaluating the set of machine learning models based on the test dataset.

9. A system, comprising:
a set of machine learning models comprising at least a first machine-learned model; and
a computer configured to:
obtain a survey dataset regarding a geological region of interest, the geological region of interest comprising a set of drilled wells, the survey dataset comprising vertical seismic profiling data associated with the set of drilled wells and well data for each drilled well in the set of drilled wells;
extract, from the vertical seismic profiling data, a first wavelet;
construct a set of pseudo-wells comprised by the geological region of interest;
determine, for each pseudo-well in the set of pseudo-wells, a reflectivity series based on the well data of the set of drilled wells;
generate a first synthetic seismic dataset for each pseudo-well in the set of pseudo-wells based on the reflectivity series for that pseudo-well and the first wavelet;
obtain target data corresponding to an earth property for each pseudo-well;
train the set of machine learning models comprising the first machine-learned model to predict earth property data given a vertical seismic profiling dataset using the first synthetic seismic dataset and target data of one or more pseudo-wells in the set of pseudo-wells;
determine, with the set of machine learning models, predicted earth property data from a field vertical seismic profiling dataset; and
plan a wellbore path using the predicted earth property data.

10. The system of claim 9, wherein the computer is further configured to:
determine a location of a hydrocarbon reservoir in the geological region of interest using the predicted earth property data; and
plan the wellbore path so as to cause a wellbore to penetrate the hydrocarbon reservoir based on the location.

11. The system of claim 10 further comprising a drilling system, the drilling system configured to:
drill the wellbore guided by the planned wellbore path.

12. The system of claim 9, wherein the set of machine learning models further comprises a second machine-learned model, the computer further configured to:
generate, based on the first wavelet, a second wavelet;
generate a second synthetic seismic dataset for each pseudo-well in the set of pseudo-wells based on the reflectivity series for that pseudo-well and the second wavelet; and
train the set of machine learning models to predict the earth property data using the first synthetic seismic dataset, the second synthetic seismic dataset and the target data of one or more of pseudo-wells in the set of pseudo-wells.

13. The system of claim 12 wherein the train the set of machine learning models comprises:
train the first machine-learned model using the first synthetic seismic dataset and the second synthetic seismic dataset; and
train the second machine-learned model using the second synthetic seismic dataset or an output of the first machine-learned model, and the target data of one or more of the pseudo-wells.

14. The system of claim 9 wherein the computer is further configured to:
generate, using the well data, at least one three-dimensional volume for the geological region of interest;
generate, for each pseudo-well, a pseudo-well log by traversing the at least one three-dimensional volume; and
determine the reflectivity series using the pseudo-well log.

15. The system of claim 14 wherein the at least one three-dimensional volume comprises a density volume and a velocity volume, wherein determine the reflectivity series for each pseudo-well comprises:
determine a depthwise difference in impedance from an impedance log for each pseudo-well, wherein each impedance log is a depthwise product of a density log and a velocity log for each pseudo-well.

16. The system of claim 9 wherein the computer is further configured to:
evaluate the set of machine learning models based on a validation set, wherein the validation set comprises the vertical seismic profiling data associated with the set of drilled wells and the well data for each drilled well in the set of drilled wells;
obtain a test dataset from a well not included in the set of drilled wells, wherein the test dataset comprises vertical seismic data and well data for the well not included in the set of drilled wells; and
evaluate set of machine learning models based on the test set.

17. A non-transitory machine-readable medium comprising a plurality of machine-readable instructions executed by one or more processors, the plurality of machine-readable instructions causing the one or more processors to perform a method comprising:
obtaining a survey dataset regarding a geological region of interest, the geological region of interest comprising a set of drilled wells, the survey dataset comprising vertical seismic profiling data associated with the set of drilled wells and well data for each drilled well in the set of drilled wells;
extracting, from the vertical seismic profiling data, a first wavelet;
constructing a set of pseudo-wells comprised by the geological region of interest;
determining, for each pseudo-well in the set of pseudo-wells, a reflectivity series based on the well data of the set of drilled wells;
generating a first synthetic seismic dataset for each pseudo-well in the set of pseudo-wells based on the reflectivity series for that pseudo-well and the first wavelet;
obtaining target data corresponding to an earth property for each pseudo-well;
training a set of machine learning models comprising at least a first machine-learned model to predict earth property data given a vertical seismic profiling dataset using the first synthetic seismic dataset and target data of one or more of pseudo-wells in the set of pseudo-wells;
determining, with the set of machine learning models, predicted earth property data from a field vertical seismic profiling dataset; and
planning a wellbore path using the predicted earth property data.

18. The non-transitory machine-readable medium of claim 17, the method further comprising:
determining a location of a hydrocarbon reservoir in the geological region of interest using the predicted earth property data; and
planning the wellbore path so as to cause a wellbore to penetrate the hydrocarbon reservoir based on the location.

19. The non-transitory machine-readable medium of claim 18, the method further comprising:
drilling the wellbore guided by the planned wellbore path.

20. The non-transitory machine-readable medium of claim 17, wherein the set of machine learning models further comprises a second machine-learned model, the method further comprising:
generating, based on the first wavelet, a second wavelet;
generating a second synthetic seismic dataset for each pseudo-well in the set of pseudo-wells based on the reflectivity series for that pseudo-well and the second wavelet; and
training the set of machine learning models to predict the earth property data using the first synthetic seismic dataset, the second synthetic seismic dataset and the target data of one or more of pseudo-wells in the set of pseudo-wells.
